(19) United States
(12) Patent Application Publication
(10) Pub. No.: US 2011/0244433 A1
(43) Pub. Date: Oct. 6, 2011

(54) Letter play

(76) Inventor: John J. Sweeney, Allentown, PA (US)

(21) Appl. No.: 13/065,785

(22) Filed: Mar. 30, 2011

Related U.S. Application Data
(60) Provisional application No. 61/341,550, filed on Apr. 1, 2010.

(51) Int. Cl. G09B 19/00

(52) U.S. Cl. 434/167

(57) ABSTRACT

A spelling exercise in game format. The exercise consists of mini sets of letters two or more of which are used in combination to form a final letter set from which letters are chosen to form words. The mini sets are tested prior to production to insure that any final letter set made will have words scrambled within it. A version of the fore mentioned exercise that has mini sets made of three vowels and mini sets made of five consonants. A mini vowel set and a mini consonant set are randomly chosen to make a final letter set. A version of the fore mentioned exercise that uses playing cards to randomly select the mini sets. A version of the fore mentioned exercise that uses a multi sided spinning top to select the mini sets.

### CROSS-REFERENCE TO RELATED APPLICATIONS

This application claims the benefit of provisional patent application Ser. No. 61/341,550 filed 2010 Apr. 1 by the present inventor.

### FEDERALLY SPONSORED RESEARCH

Not applicable

### SEQUENCE LISTING OR PROGRAM

Not Applicable

### BACKGROUND

1. Field of Invention

This invention is a method of organizing a scrambled letter spelling exercise and a unique randomizer.

2. Prior Art

Since ancient times parents and educational institutions have recognized the value of using scrambled letter exercises to give students enjoyable practice of their spelling skills. Evidence of this fact is the Hebrew Dreidel, an ancient way to teach letters to children using a Sinning Top randomizer to select the letters. It has long been known that children enjoy a Spinning Top toy and this added entertainment value is a great utility of this kind of randomizer. A randomizer is an instrument that selects an outcome from a group of possible outcomes in a way that is random and adds the element of chance to the selection process. Using the Spinning Top or any other random way of selecting the letters adds an element of chance to the exercise and increases the enjoyment. The U.S. Pat. No. 459,832 (1891) uses many Spinning Tops as a random way to select individual letters to form a letter set from which the players may spell words, however there is no guarantee that the letter set generated would have words scrambled within it, thus leading to the frustration of the students. In some exercises a letter set from which no word can be formed is acceptable. This is not the case with my invention, LETTER PLAY. All the letter sets, from which students try to spell words from, are designed to have words scrambled within them. A student is assured that if he applies himself he will find words.

Games like U.S. Pat. No. 3,744,154 (1973) use word fragments as well as individual letters as the letter set from which words can be formed. A Word Fragment is a linear group of letters which must be used in the order given. Example: the Word Fragment “ISH” with the individual letters of Y, B, O, as the letter set. The word BOYISH can be made from this letter set but the word SOB cannot be made from this letter set because it would only use part of the word fragment. With my invention the students will be able to use the letters in any order to make any word that they can.

In any game or exercise where the letters are randomly selected in forming a letter set the challenge of having vowels in the final set of letters must be addressed if the set is to be assured of having words within it. The U.S. Pat. No. 2,491,883 tries to assure that the letter set generated by the rolling of dice will have words scrambled within it by having some dice with only vowels. This does assure there will be vowels in the final letter set, but the randomness of this system does not assure that it is possible to form a word from every possible generated letter set. My invention which uses mini sets of letters to form a final set of letters not only assures that there will be vowels in the final letter set from which students form words but it insures that words will be able to be formed from the letters in every possible final letter set.

### SUMMARY

In summary my system is to use multiple mini sets of letters, the letters within which are selected so that the letters from any pair of mini sets can spell multiple words. At least two mini sets are randomly chosen to be used in combination to form the final letter set for exercise play.

My preferred version of this system segregates the vowels into vowel only mini sets and consonants into consonants only mini sets. It takes at least one vowel mini set and one consonant mini set to make a Final Letter Set for exercise play. The vowel mini sets have three vowels so it takes some skill to pick out vowel pairing combinations that use two vowels. The consonant mini sets have five consonants so that it will take some skill to pick out consonant pairings that use three consonants as well as make the students choose between which of the remaining consonants to use with the three consonant pairing. This preferred version uses shuffled cards as the randomized selection method for the mini sets. The words spelt are given a point value, one point for each vowel sound in a word and one point for each multiple consonant combination that makes a single or blended sound. The utility of giving one point for each vowel sound encourages students to make multiple syllable words, and giving a point for each multiple consonant pairing encourages students to use these pairings in their words.

A second version of this system uses a Spinning Top randomizer similar to a DREIDEL as the randomizer. In this version of the system there are only four mini vowel sets. The letters in the vowel mini sets are chosen so that each possible two vowel combination will be in at least one of the four vowel mini sets. There is one mini vowel set and two mini consonant sets displayed on each side of the Spinning Top. The region where the consonant mini sets are displayed is tapered inward five degrees from the area where the vowel mini sets are displayed. The Spinning Top is spun twice per round. The first spin determines the vowel mini set. The second spin, along with a rule that states the top consonant mini set is selected in odd numbered rounds and the bottom consonant mini set is selected in even numbered rounds, determines the consonant mini set selected. The words spelt are given a point value. Each letter in the word is worth as many points as the total number of letters in the word.

### BRIEF DESCRIPTION OF THE DRAWINGS

FIG. 1 shows the card face with the consonant mini set, JGZRD. This mini set has in it the consonant combinations DR GR.

FIG. 2 shows the card face with the consonant mini set, KNHCL. This mini set has in it the consonant combinations KN CK CL CH.

FIG. 3 shows the card face with the consonant mini set, BLMRS. This mini set has in it the consonant combinations BL SL SM.

FIG. 4 shows the card face with the consonant mini set, SNYFT. This mini set has in it the consonant combinations SN ST.

FIG. 5 shows the card face with the consonant mini set, VRCST. This mini set has in it the consonant combinations CR SC ST TR STR SCR.

FIG. 6 shows the card face with the consonant mini set, WRLHD. This mini set has in it the consonant combinations DR WH WR.

FIG. 7 shows the card face with the consonant mini set, XTSRP. This mini set has in it the consonant combinations SP ST STR SPR.

FIG. 8 shows the card face with the consonant mini set, GLTHN. This mini set has in it the consonant combinations TH GL.

FIG. 9 shows the card face with the consonant mini set, PHRSY. This mini set has in it the consonant combinations PR SP SPR SPH.

FIG. 10 shows the card face with the consonant mini set, FLRYN. This mini set has in it the consonant combinations FL FR.

FIG. 11 shows the card face with the consonant mini set, DTNHM. This mini set has in it the consonant combinations TH.

FIG. 12 shows the card face with the consonant mini set, CMKYS. This mini set has in it the consonant combinations SC SM SK.

FIG. 13 shows the card face with the mini vowel set, IAE.

FIG. 14 shows the card face with the mini vowel set, OIU.

FIG. 15 shows the card face with the mini vowel set, AEO.

FIG. 16 shows the card face with the mini vowel set, EUA

FIG. 17 shows the card face with the mini vowel set, AIO.

FIG. 18 shows the card face with the mini vowel set, UOA.

FIG. 19 shows the card face with the mini vowel set, EIO.

FIG. 20 shows the card face with the mini vowel set, UOE.

FIG. 21 shows the card face with the mini vowel set, IUA.

FIG. 22 shows the card face with the mini vowel set, UEI.

FIG. 23 shows the back of the vowel cards. The word VOWELS is displayed on the back of the vowel cards

FIG. 24 shows the back of the consonant cards. The word CONSONANTS is displayed on the back of the consonant cards.

FIG. 25 shows two sides of the unique Spinning Top randomizer. These sides display the vowel mini sets AEO, IUO, the consonant mini sets JDZRG, KNHLC, VRSCT, and WLRHD, this Figure also shows the rounded bottom area, the small semi sphere upon which it spins, and the handle at the top which is used to spin the Spinning Top.

FIG. 26 shows the two sides of the unique Spinning Top randomizer not shown in FIG. 25. These sides display the vowel mini set s AEI, AEU, the consonant mini sets PHRSY, DTNHM, FLRYN, and XTSRP, this Figure also shows the rounded bottom area, the small semi sphere upon which it spins, and the handle at the top which is used to spin the Spinning Top.

### DETAILED DESCRIPTION OF LETTER PLAY

The utility of my invention Letter Play is that by design it assures that the final letter set that the students pick letters from to spell words will have multiple words scrambled within it. This is achieved by having two or more mini sets of letters randomly selected from a group of multiple mini sets of letters to form the final letter set for that round of play. An example of a group of multiple mini sets is set #1 DOG, set #2 HOS, set #3 TE, HOG and SOD can be spelt from a final letter set made from mini sets #1 and #2, TOE and DOE can be spelt from a final letter set made from mini sets #1 and #3, THOSE and HOSE can be spelt from a final letter set made from mini sets #2 and #3. During the development of the game the letters within the mini sets, which together make up the group of multiple mini sets, are selected so that any mini set in combination with any other mini set will produce a final letter set that will have words scrambled within it.

The utility of using 2 or more mini sets to make the final letter set is to increase the variety of final letter sets that can be produced, instead of just having a vast number of final letter sets. In my preferred version of Letter Play which uses a deck of cards for the randomizer I have a deck of 10 mini vowel sets and 12 mini consonant sets. This yields a total of 120 possible final letter sets from only 22 cards. An exercise that did not use mini sets to form a final set would have to print a card for each final set, a deck of 120 cards.

When the exercise uses more than 2 mini sets to make up the final letter set it does so to allow for the spelling of even longer words.

The reason why my exercise is different from the classic anagram game, where you compete to spell words using a word as the final letter set to work from, is because my method achieves a vast variety of final letter sets from a small number of mini sets through multiple combinations of the mini sets. An anagram exercise would achieve a vast variety of final letter sets by listing a vast number of words.

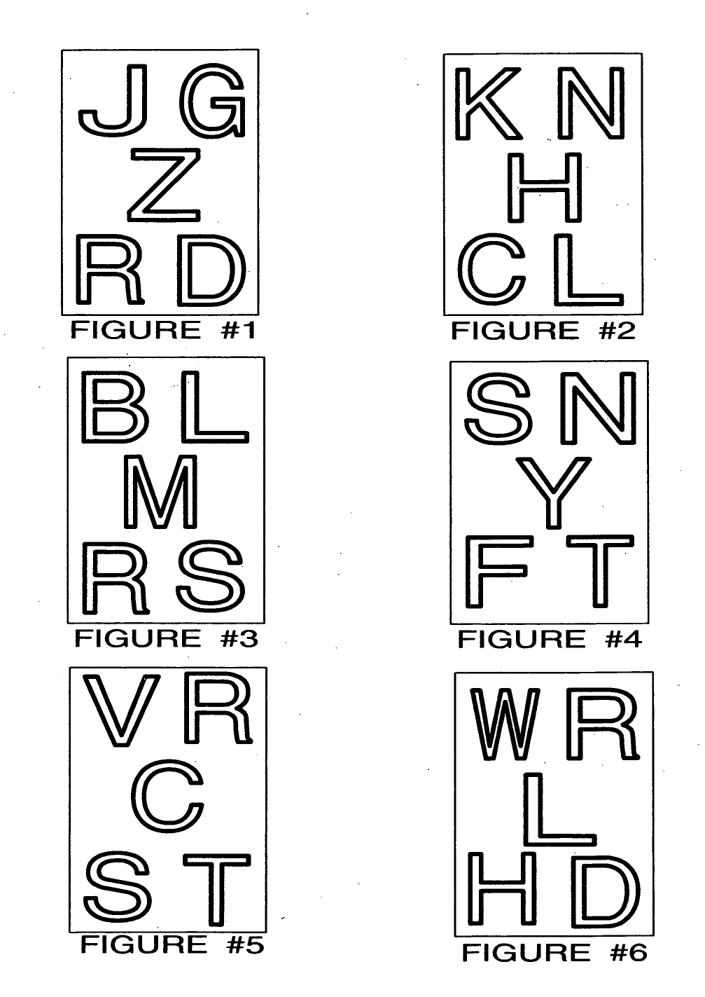

My preferred version of Letter Play uses a deck of cards as the randomizer with one mini set printed on the face of each card. This version segregates the vowels into mini sets with only vowels in them, as shown in FIGS. 13 to 22, and mini sets with only consonants in them, as shown in FIGS. 1 to 12. The back of the cards have different printing on them to distinguish the vowel cards from the consonant cards when face down as shown in FIGS. 23 and 24. In this version at least one mini set must be a vowel set and at least one mini set must be a consonant set. The mini sets for vowels have three vowels in them as seen in FIGS. 13 to 22. The utility of having three vowels in the vowel mini sets is that this makes these sets as simple as the mini sets for vowels can be and still require some skill for the players to pick out two letter vowel combinations that combine to make one sound. The utility of having letters that are used in combination to represent sounds heard in words is that it increases the number of sounds represented by, the mini set without increasing the number of letters needed.

The mini vowel sets are as follows:

IAE, as shown in FIG. 13 which has represented in it the vowel sounds MAT MET MIT MAKE MIKE MEEK, at least 6 sounds from only 3 letters.

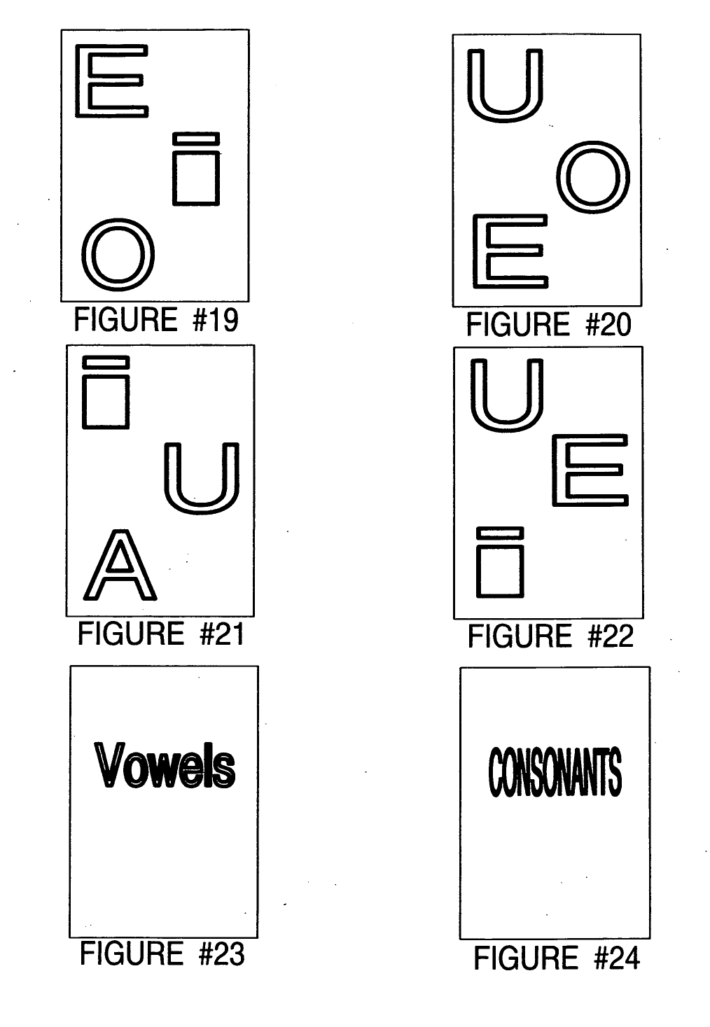

OIU, as shown in FIG. 14 which has represented in it the vowel sounds HIT HOT HUT FLUIT SHOUT TOIL, at least 6 sounds from only 3 letters.

AEO, as shown in FIG. 15 which has represented in it the vowel sounds POT PAT PET ROPE APE OAR, at least 6 sounds from only 3 letters.

EUA, as shown in FIG. 16 which has represented in it the vowel sounds BAT BUT BET RATE HUE HE, at least 6 sounds from only 3 letters.

AIO, as shown in FIG. 17 which has represented in it the vowel sounds PAT PIT POT PAIL BOIL BOAT, at least 6 sounds from only 3 letters.

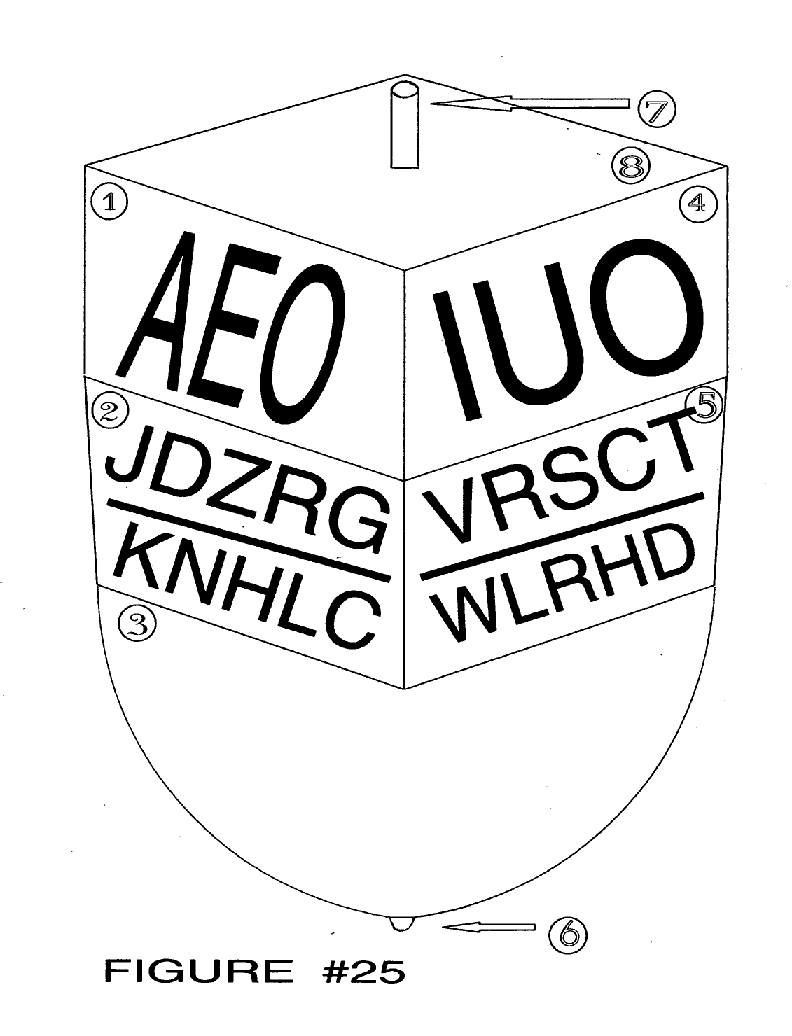

UOA, as shown in FIG. 18 which has represented in it the vowel sounds PAT POT PUT OUT TAUGHT TOAT, at least 6 sounds from only 3 letters.

EIO, as shown in FIG. 19 which has represented in it the vowel sounds PET PIT POT PETE PIPE OIL, at least 6 sounds from only 3 letters.

UOE, as shown in FIG. 20 which has represented in it the vowel sounds PET POT PUT PETE ROPE OUT, at least 6 sounds from only 3 letters.

IUA, as shown in FIG. 21 which has represented in it the vowel sounds HIT HUT HAT PAIL TAUGHT FLUID, at least 6 sounds from only 3 letters.

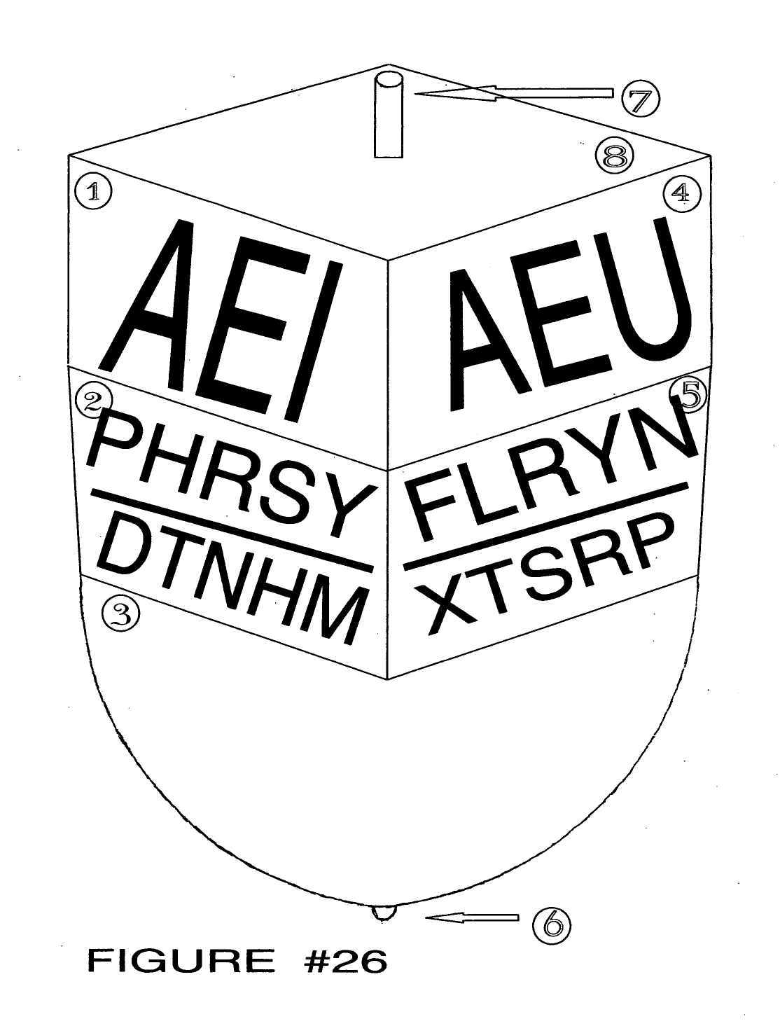

UEI, as shown in FIG. 22 which has represented in it the vowel sounds BUT BET BIT HUE HE HIDE, at least 6 sounds from only 3 letters.

There are ten vowel mini sets in all as shown in FIGS. 13 thru 22. There are ten mini vowel sets because this is the maximum number of sets that can be made without repeating a set. The order that the letters appear in does not matter since the students can arrange the letters as they like within the words they spell. Changing the order of the letters in the mini sets will not change the number of words that can be spelt, so a vowel mini set AEO and OAE would be the same mini set for the exercise, yielding the same results, the same number of possible words spelt.

The mini sets for consonants have five consonants in them as shown in FIGS. 1 thru 12. The utility of using five consonants is because there are not only two letter consonant combinations that make one sound, but also three letter combinations that make one sound such as STR and SPR. I do not use four letter consonant mini sets because then their will only be one letter arrangement choice, if the three letter consonant sound was SPR, then the only arrangement choice would be the fourth consonant a vowel and the SPR combination. By using five letters the students must make a choice of which consonant to use along with the SPR combination. If I used four letter consonant mini sets for the mini sets without a three letter combination this would tell the students not to look for a three letter combination in the mini set, so I use the same number of letters in all the consonant mini sets.

There are 12 mini consonant sets as shown in FIGS. 1 through 12. The consonant mini sets are as follows:

JGZRD, as shown in FIG. 1, which has in it the consonant combinations DR, the G was added so the words DRAG DRUG could be spelt using the DR combination. Adding the G has the added advantage of including the GR consonant combination to the mini consonant set. The Z is added so the word GRAZE can be spelt using the GR combination. The J is added to give the additional words JUG JOG JAGGED JIG, a group of words that between them use all of the vowels including the letter d in this mini set allows for the ED suffix to be used to make multiple syllable words. This mini set is then tested with each of the vowel mini sets to make sure that at least five words can be spelt from any final letter set possible. Many other words can be spelt with this consonant combination. While having only 5 consonants the combinations mean that this set can represent the sounds heard in words seven different ways increasing the number of words that can be spelt.

KNHCL, as shown in FIG. 2, which has in it the consonant combination KN, the C is added so the word KNOCK can be spelt, the addition of the C has the added advantage of including the CK combination as well. Adding the L includes the CL combination to the mini consonant set which enables the words UNCLE CLOCK CLACK to be spelt. Adding the H includes the CH combination into the mini consonant letter set. This allows the words CHUNK and CHILL to be spelt. This five letter consonant set is then tested with all of the vowel mini sets to make sure that at least five words can be spelt from any possible final letter set. Many other words can be spelt with this consonant mini set. While only having 5 letters the combinations mean that the set can represent sounds heard in words 9 different ways.

BLMRS as shown in FIG. 3 which has in it the consonant combination BL, the S is added so the word BLISS can be spelt using the BL combination. Adding the S has the added advantage of including the SL combination to the set. The M is added so the word SLIM can be spelt. Adding the M also includes the SM combination to the set. The word Small can be spelt The R enables the use of the BR combination the word BRIM can be spelt. Including the letter R in this mini consonant set allows for the prefixes RE and BE to be used to make multiple syllable words. Many other words can be spelt with this consonant set. This set has been tested with all the vowel sets to make sure that at least five words can be spelt from any possible final letter set. While having 5 consonants this set can represent the sounds heard in words nine different ways.

SNYFT, as shown in FIG. 4 which has in it the consonant combination SN, the T is added so the word SNOUT can be spelt, the addition of the T has the added advantage of including the ST combination into the set allowing STUFF to be spelt using the F. Including the letters NG in this mini set allows for the suffix ING to be used to make multiple syllable words. Many other words can be spelt with this mini set. This mini set has been tested with all the vowel mini sets to make sure that at least five words can be spelt from any possible final letter set. While only having 5 consonants the combinations mean that this set can represent the sounds heard in words seven different ways increasing the number of words possible to spell.

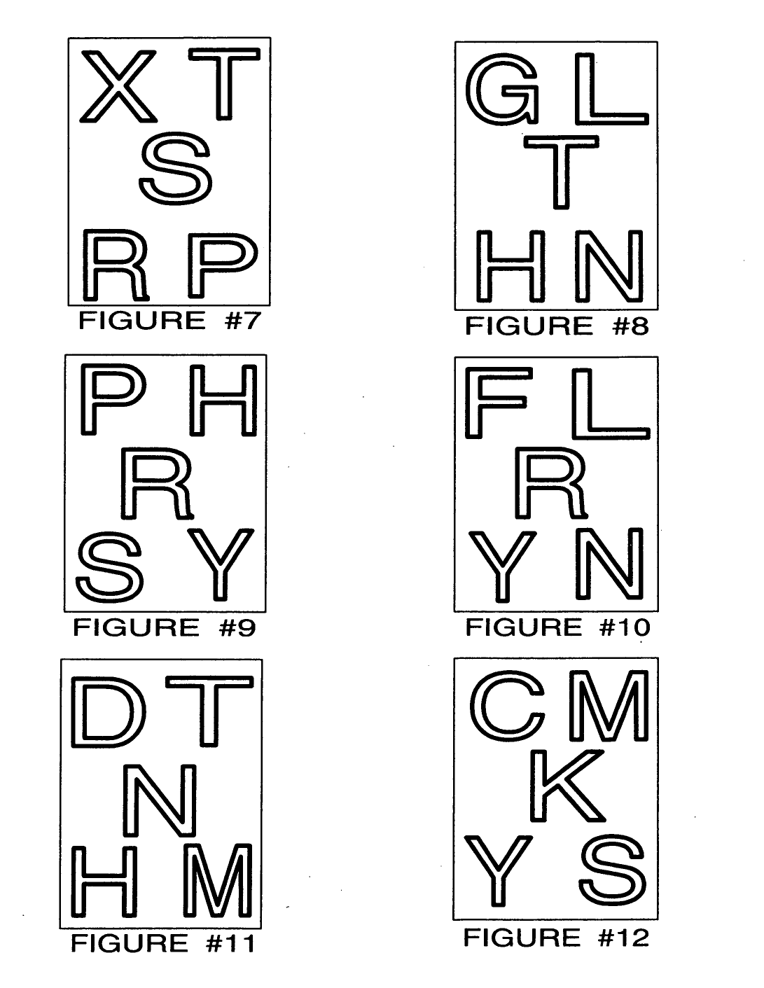

VRCST, as shown in FIG. 5 which has in it the consonant combination CR the S is added so the word CROSS can be spelt, adding the S has the added advantage of including the SC combination to the set, the T is added enabling the spelling of the word SCAT, adding the T has the added advantage of including the ST, TR, and STR combinations allowing the spelling of the word TRUST, adding the V enables the spelling of CRAVE. Many other words can be spelt with this mini set. This mini set has been tested with all the vowel mini sets to make sure that at least 5 words can be spelt from any possible final set. While having only 5 consonants the combinations mean that this set can represent the sounds heard in words 10 different ways increasing the number of words spelt.

WRLHD, as shown in FIG. 6 which has in it the consonant combination DR, the letters L and W were added to enable the spelling of DRILL and DRAW, the H is added to enable the spelling of HAD HEW HILL HOLD HULL a group of words that use every vowel between them. Many other words can be spelt with this consonant mini set. This mini set has been tested with all the vowel mini sets to make sure that at least 5 words can be spelt from any possible final letter set. While only having 5 consonants the combinations mean this set can represent the sounds heard in words six different ways increasing the number of words possible to spell.

XTSRP, as shown in FIG. 7 which has the combination SP in it, the T is added so the word SPOT can be spelt, adding the T has the added advantage of including the ST combination in the set, adding the R allows the word STORE to be spelt, adding the R has the added advantage of including the consonant combinations STR and SPR allowing the words SPROUT and STRAP to be spelt, the X is added to allow the spelling of TAX TEXT SIX SOX TUX, a group of words that include every vowel. Many other words can be spelt with this consonant set. This consonant mini set has been tested with all the vowel mini seta to make sure that at least 5 words can be spelt from any possible final letter set. While only having 5 consonants the combinations mean that this set can represent the sounds found in words in 9 different ways increasing the number of words possible to spell.

GLTHN, as shown in FIG. 8 which has the consonant combination TH in it the G is added so the word THUG can be spelt, the addition of the letter L includes the GL combination in the set and allows the word GLUT to be spelt, the addition of the N allows the spelling of the words TAN HEN HIT HOT HUT a group of words that include every vowel. Including the letters TN in this mini consonant set allows the suffix TION to be used to make multiple syllable words. Many other words can be spelt with this mini consonant set. This mini set has been tested with all the vowel mini sets to make sure that at least 5 words can be spelt from any possible final letter set. While only having 5 consonants the combinations mean that this set can represent the sounds heard in words 7 different ways increasing the number of words possible to spell.

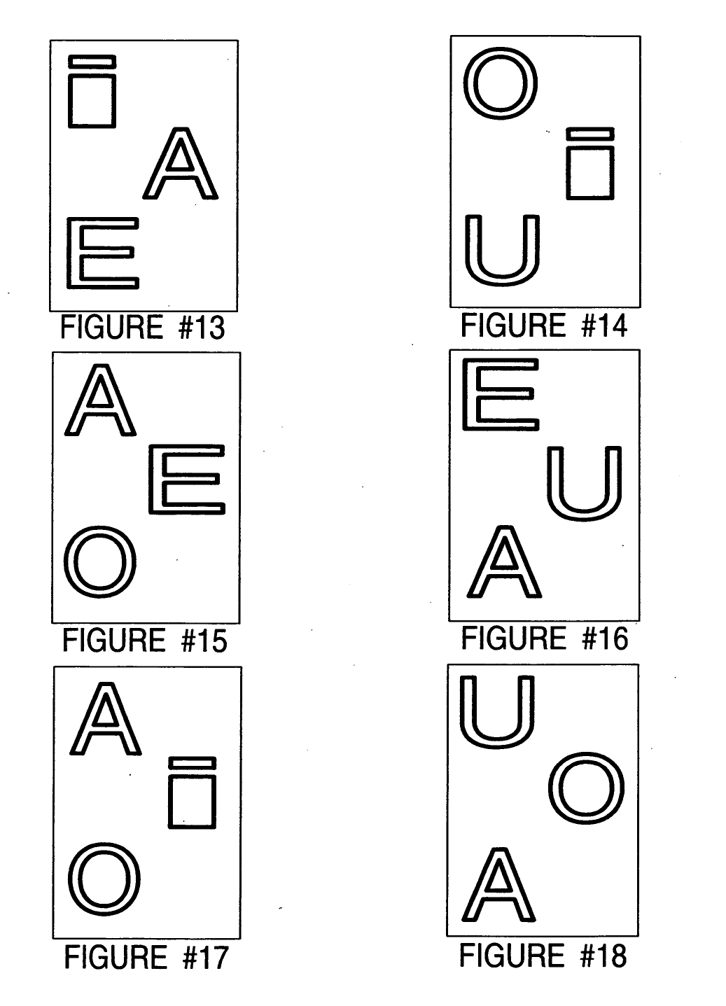

PHRSY, as shown in FIG. 9 which has the consonant combination PR, the letter S is added to allow the spelling of the word PROSE, the addition of S includes SP and SPR combinations in the set allowing SPORE SPRAY to be spelt with the addition of Y, adding the H includes the SPH combination to the set allowing the word SPHERE to be spelt. Including the letters PR in this mini consonant set allows for the prefix PRE to be used to make multiple syllable words. Many other words can be spelt with this mini set. This mini set has been tested with all the vowel mini sets to make sure that at least 5 words can be spelt from any possible final letter set. While having only 5 consonants the combinations mean that this set can represent the sounds heard in words 9 different ways increasing the number of words possible to spell.

FLRYN, as shown in FIG. 10 which has the consonant combination FL, adding the letter R allows the word FLAIR to be spelt, the addition of the R includes the FR combination in the set allowing the spelling of the word FRILL, adding N and Y allow the spelling of FRAY FERN. Many other words can be spelt from this mini set. This mini set has been tested with all the vowel mini sets to make sure that at least 5 words can be spelt from each possible final letter set. While only having 5 consonants the combinations mean that the set can represent sounds heard in words 7 different ways increasing the number of words possible to spell.

DTNHM, as shown in FIG. 11, which has the consonant combination TH the addition of the letter M allows for the spelling of the word THEM, the addition of the ND allows for the spelling of AND DEN DIN NOD NUT, a group of words that use every vowel. Many other words can be spelt with this mini set. This mini set has been tested with all the vowel mini sets to make sure that at least 5 words can be spelt from any possible final letter set.

CMKYS, as shown in FIG. 12 which has the consonant combination SC, the addition of the letter M allows for the spelling of the word SCAM, it also adds the consonant combination SM to the set, adding the letter K enables the spelling of the word SMOKE, it also adds the consonant combination SK, the addition of the Y enables the spelling of SKY. Many other words can be spelt with this mini set. This mini set has been tested with all the vowel mini sets to make sure that at least 5 words can be spelt from any possible final letter set. While only having 5 consonants the combinations mean that this set can represent the sounds heard in words 8 different ways increasing the number of words possible to spell.

There are twelve consonant cards for small scale production concerns. The number of playing cards that can be cut out of one 8½ by 11 sheet of paper is 12. The letters for these consonant letter mini sets were chosen by first choosing a two letter consonant combination like DR then adding three other letters, then the mini set of 5 consonants is tested with the ten mini vowel sets to make sure at least 5 words can be spelt from each of the final letter sets that these mini sets can make. The deck of cards has 22 cards, ten vowel cards and twelve consonant cards.

The basic rules for this preferred version in an exercise that uses a deck of cards as a randomizer method of mini set selection are as follows; the cards are placed face down in 2 stacks one stack having only vowel cards the other stack having only consonant cards. One player turns over a vowel set card another player turns over a consonant set card, the letters on the two cards make up the final letter set for that round. All players have 5 minutes to write down all the words they can make using at least one letter from each card. The players receive points based on the words they spell. One point is given for each vowel sound and one point for each two or three consonant combination in each word they spell. The players play three rounds then total their scores for all the rounds combined. The player with the most points wins.

Sample Operation of Exercise Play with Three Players:

First the players set up the exercise for play. The players place the vowel cards in one deck and shuffle them then they place them face down. Next the players place the consonant cards in one deck and shuffle them then they place them face down next to the vowel card deck. Each player has a pencil and a piece of paper. Player #1 is chosen to be the time keeper, player #2 is chosen to be the vowel card turner, player #3 is chosen to be the consonant card turner.

After setting the game up the time keeper looks at digital clock and sees that it reads 1:12, he announces that when the clock reads 1:13 he will say “go” this will be the signal for the other players to each turn over one card and the round will begin, and he says the round will end when the clock reads 1:18.

The clock changes to 1:13 the time keeper says “Go” and the vowel card keeper turns over a vowel card and the consonant keeper turns over a consonant card. The vowel card turned over has the mini set IAE, as shown in FIG. 13, the consonant card turned over has the mini set JGZRD, as shown in FIG. 1, this makes a final set of IAEJGZRD. All of the players begin to write down words using the letters in this final letter set. Player #2 is the first to see the digital clock reads 1:18 he calls the round over and all pencils stop. Player #1 wrote the words REGAL for 2 points, JARED for 2 points, a total of 6 points for the round. Player 2 wrote the words DARE for 1 point, DAZE for 1 point, RIDE for 1 point, for a total of 3 points for the round. Player #3 wrote the words JAR for 1 point, JIG for 1 point, DIE for 1 point, JAZZ for 1 point, for a total of 4 points for the round. After every one is done calculating their score for that round the time keeper sees the digital clock reads 1:22 he announces that when the clock reads 1:23 he will say “Go” and the 2^{nd} round will begin and that it will end at 1:28.

The clock changes to 1:23 the time keeper says “Go” the vowel card turner turns a vowel card face up and places it on top of the vowel card from the last round, the consonant card turner turns a consonant card face up and places it on top of the consonant card from the last round. The vowel card for this round has the vowel mini set AIO, as shown in FIG. 17, and the consonant card for this round has the consonant mini set KNHCL, as shown in FIG. 2, this makes a final letter set of AIOKNHCL. All of the players begin to write down words using the letters in the final set. Player #1 is the first to see that the clock reads 1:28 and he calls the round over and all pencils stop. Player #1 wrote the words LOCK for 2 points, CLOCK for 3 points, CHIN for 2 points, a total of 7 points for the round. Player #2 wrote CAN for 1 point, CALL for 1 point, COLA for 2 points, a total of 4 points for the round. Player #3 wrote COLA for 2 points, NO for 1 point, KILL for 1 point, HALL for 1 point, for a total of 5 points for the round. After every one is done calculating their score for that round the time keeper sees the digital clock reads 1:31, he announces that the third and last round will begin when the clock reads 1:32.

The clock changes to 1:32, the time keeper says “Go” the vowel card turner turns face up a vowel card and places it down on top of the vowel card for the previous round, the consonant card turner turns face up a consonant card and places it face up on the consonant card from the previous round. The vowel card for this round has the mini set UOA, as shown in FIG. 18 the consonant card has the mini set BLMRS, as shown in FIG. 3, this makes a final letter set of UOABLMRS for the round. All the players begin to write down words using the letters in the final letter set. Player #1 wrote SLAB for 2 points, BLOSSOM for 3 points, SLAB for 2 points, for 7 points for the round. Player #2 wrote BULL for 1 point, BAM for 1 point, BASS for 1 point, for 3 points for the round. The players total their points for the game. Player #1 has a game total of 20 points. Player #2 has a game total of 10 points, Player #3 has a game total of 12 points. Player #1 wins Player #2 is in second Player #3 is in third.

A second version of this game system uses a unique randomizer. This randomizer is displayed in FIG. 25 and FIG. 26.

FIG. 25 Area 1 displays the vowel mini set AEO. Area 2 tapers inward from area 1 by 5 degrees, this taper highlights the distinction between Area 1 and Area 2. Area 2 displays the consonant mini set JDZRG, and KNHLC separated by a horizontal line. Area 3 is the rounded area at the bottom of the Spinning Top. Area 4 displays the vowel mini set IUO. Area 5 tapers inward from Area 4 by 5 degrees, this taper highlights the distinction between Area 4 and Area 5. Area 5 displays the consonant mini sets VRSCT, and WLRHD separated by a printed horizontal line. Area 6 shows the small 1/16^{th} of an inch radius semi sphere at the very bottom of the Spinning Top which is the point upon which the Spinning Top spins. Area 7 shows the handle at the top which the players use to spin the Spinning Top. Area 8 shows the flat top of the Spinning Top.

FIG. 26 Area 1 displays the vowel mini set AEI. Area 2 tapers inward from area 1 by 5 degrees, this taper highlights the distinction between Area 1 and Area 2. Area 2 displays the consonant mini set PHRSY, and DTNHM separated by a horizontal line. Area 3 is the rounded area at the bottom of the Spinning Top. Area 4 displays the vowel mini set AEU. Area 5 tapers inward from Area 4 by 5 degrees, this taper highlights the distinction between Area 4 and Area 5. Area 5 displays the consonant mini sets FLRYN, and XTSRP separated by a printed horizontal line. Area 6 shows the small 1/16^{th} of an inch radius semi sphere at the very bottom of the Spinning Top which is the point upon which the Spinning Top spins. Area 7 shows the handle at the top which the players use to spin the Spinning Top. Area 8 shows the flat top of the Spinning Top.

The randomizer is a four sided Spinning Top. It has four sides thus it has four possible outcomes, with multiple desired outcomes (mini letter sets) on each side. This randomizer has fewer possible outcomes than desired. In the past this has been overcome by using the randomizer along with a chart. The randomizer would select a group of outcomes on the chart then a rule would determine which outcome from the group would be selected.

The utility of my randomizer has the group of outcomes displayed upon the randomizer itself. The randomizer selects a group of outcomes (mini letter sets). Individual outcomes within the group of outcomes are distinguished from each other by a slight taper, as shown in FIG. 25 area 2, also by a horizontal line as shown in FIG. 25 Area 2. Which of the outcomes within the group of outcomes is selected is determined by rule. The rules that determine which outcome is indicated are as follows. There are two spins per round. The first spin determines the mini vowel set for the round. The second spin determines the mini consonant set for the round. If it is a odd numbered round then the top mini consonant set is used, if it is an even numbered round then the bottom mini consonant set is used. This system of multiple spins and outcome groups and rule allows this single randomizer to be used to select from results the number of which are more than the number of outcomes the randomizer has. This unique randomizer eliminates the need for a chart by in effect having the chart displayed upon the randomizer.

This second version further limits the vowel mini sets to only four three vowel sets. The utility of using four three vowel mini sets is that it simplifies to the fewest possible three vowel sets and still have all possible two vowel combinations in at least one of the sets, this is why the randomizer must have at least four sides. Using the four three vowel mini sets AEI as shown in Area 1 on FIG. 26, AEU as shown in Area 4 on FIG. 26, AEO as shown in Area 1 on FIG. 25, IUO as shown in Area 4 on FIG. 25, the letter A is paired with E and I in the first set, O in the third and U in the second, the letter E is paired with the letter A and I in the first set the letter O in the third set and the letter U in the second set, the letter I is paired with A and E in the first set the letter O in the fourth set the letter U in the fourth set. The letter O is paired with the letter A and E in the third set the letter I and U in the fourth set.

This unique Spinning Top randomizer is similar to a DREIDEL. This Randomizer has four sides with one vowel mini set and two consonant mini sets displayed on each side. This gives us a game with four mini vowel sets and eight mini consonant sets despite the fact that the Spinning Top only has four sides. Which of the twelve mini sets displayed on the Spinning Top are to be used to make up the final letter set is determined by having the Spinning Top spun twice each round. The first time the Spinning Top is spun the face up vowel mini set is chosen. The second time the Spinning Top is spun one of the face up consonant mini sets are chosen, if the game round is an odd number then the top consonant mini set is chosen, if the round is an even number then the bottom consonant mini set is chosen. In a game with four rounds the first round will use the top consonant mini set, the second round will use the bottom consonant mini set, the third round will use top consonant mini set, the fourth round will use the bottom consonant mini set. This version uses a unique scoring system. The value of each letter in a word is equal to the number of letters in the word. Each letter in a three letter word is worth three points thus a three letter word is worth nine points. Each letter in a four letter word is worth four points thus a four letter word is worth sixteen points. This scoring system can be used as an introduction to the math principle of squaring numbers. The inventor has envisioned many embodiments of this system and has changed the number of consonant sets to eight, as compared to twelve in the card deck version to show that the number of sets is not essential.

Sample of Game Play with Three Players:

First the game players set the game up. They each get a pencil and paper to write down words with. They pick player #1 to be the time keeper, player #2 to spin the Spinning Top the first time each round, the third player to spin the Spinning Top the second time each round. They decide on the number of rounds to play, they agree to play 2 rounds. The time keeper sees that the digital clock reads 4:02, he announces that the round will start at 4:03 when he says “Go”.

Player #1 sees the digital clock reads 4:03 he says “Go”. Player #2 spins the Spinning Top the Top spins then falls, area 1 from FIG. 26 lands face up. This signifies that the vowel mini set AEI is to be used for this round. All players write AEI on their paper. Player #3 then spins the Spinning Top again to determine the consonant mini set. Area 5 from FIG. 25 lands face up. Since this is the first round an odd number the top consonant mini set is chosen, VRSCT. All the players write down the mini consonant set next to the vowel mini set so each player has the final set AEIVRSCT written on their paper. The players then begin to write words using the letters in this final set. Player #2 is the first player to see the digital clock reads 4:08 he calls the round over and all pencils stop. Player #1 wrote the words SAVER for 25 points STIR for 16 points TRACE for 25 points, for 66 points for the round. Player #2 wrote the words SAT for 9 points RAT for 9 points SIT for 9 points VET for 9 points, for 36 points for the round. Player #3 wrote the words SAT for 9 points SIT for 9 points SET for 9 points for 27 points for the round. After every one is done calculating there score for the round the time keeper sees the digital clock reads 4:09, he announces that the next round will begin at 4:10.

The time keeper sees the digital clock reads 4:10 he says “Go”. Player #2 spins the Spinning Top for the first time this round. The Top lands with the area 4 from FIG. 25 face up. This means that IUO is the vowel mini set for this round, all players write the mini set down on their paper. Player #3 spins the Spinning Top for the second time this round. Area 2 from FIG. 26 lands face up. This is the second round, an even number so the bottom consonant mini set from Area 2 is used DTNHM, all players write down the mini set on their paper next to the vowel mini set so all players have the final set IUODTNHM written on their paper. All players begin to write words using the letters in the final set. Player #1 is the first to see that the digital clock reads 4:15. He calls the round over and all pencils stop. Player #1 wrote the words THIN for 16 points Thud for 16 points Hind for 16 points, for 48 points for the round. Player #2 wrote the words Dim for 9 points DUN for 9 points DOT for 9 points, for 27 points for the round. Player #3 wrote the words HIT for 9 points HOT for 9 points, for 18 points for the round. Player #1 has 114 points for the game and comes in first, player #2 has 63 points for the game and comes in second, player #3 has 45 points for the game and comes in third.

1. A scrambled letter spelling game system for two or more players comprising multiple sets of letter combinations, each said set of letter combinations being organized into consonant and vowels, each said set of consonant letter combinations being organized into a set of preselected consonant letters and each set of vowel letter combinations being organized into a set of preselected vowel letters, the sets of consonant and vowel letter combinations being randomly selected for use in spelling words that are comprised of the letters in each of the sets of consonant and vowel letter combinations selected and organized by the two or more players into words in multiple rounds of play.

2. The spelling game system of claim 1, wherein the set of consonant letter combinations contain five consonant letters.

3. The spelling game system of claim 1, wherein the set of vowel letter combinations contain three preselected vowel letters.

4. The spelling game system of claim 1, wherein said sets of consonant and vowel letter combinations are each respectively displayed on a plurality of cards for random selection by the two or more players.

5. The spelling game system of claim 1, wherein said sets of consonant and vowel letter combinations are each respectively displayed on the several sides of a spinning top for random selection by the two or more players.

6. The spinning top of claim 5, wherein each side of the top is configured to display one set of vowel letter combinations and two sets of consonant letter combinations.

7. The spinning top of claim 6, wherein the selection of the set of consonant letter combinations is dependent on the round of play.
